(19) United States
(12) Patent Application Publication
(10) Pub. No.: US 2010/0159328 A1
(43) Pub. Date: Jun. 24, 2010

(54) PREPARATION METHOD OF ZNSB-C COMPOSITE AND ANODE MATERIALS FOR SECONDARY BATTERIES CONTAINING THE SAME COMPOSITE

(75) Inventors: Cheol-Min Park, Daegu (KR); Hun-Joon Sohn, Seoul (KR)

Correspondence Address: HAMRE, SCHUMANN, MUELLER & LARSON, P.C., P.O. BOX 2902, MINNEAPOLIS, MN, 55402-0902, US

(73) Assignee: SNU R&DB FOUNDATION, Seoul (KR)

(21) Appl. No.: 12/622,771

(22) Filed: Nov. 20, 2009

(30) Foreign Application Priority Data
Dec. 23, 2008 (KR) 10-2008-0131927

(51) Int. Cl. H01M 4/58; C01B 31/00

(52) U.S. Cl. 429/229; 423/414

(57) ABSTRACT

Provided are a method for preparing a zinc antimonide-carbon composite through a mechanical synthesis process of zinc (Zn), antimony (Sb) and carbon (C), and an anode material including the composite as an active material. The method for preparing a zinc antimonide-carbon composite allows simple and rapid preparation of the composite using mechanical properties of a binary alloy of zinc antimonide. In addition, when applying the anode material including the composite as an anode active material to a secondary battery, it is possible to provide excellent initial efficiency, to prevent the problem of a change in volume caused by formation of crude particles, and to realize excellent high-rate characteristics and charge/discharge characteristics.

### CROSS-REFERENCE TO RELATED APPLICATION

This application claims priority to Korean Patent Application No. 2008-013927, filed on Dec. 23, 2009, and all the benefits accruing therefrom under 35 U.S.C. §119, the contents of which in its entirety are herein incorporated by reference.

### BACKGROUND

1. Field

This disclosure relates to a method for preparing a zinc antimonide (ZnSb)-Carbon (C) composite, and an anode material for a secondary battery including the same composite.

2. Description of the Related Art

It is important to develop alternative energy for the survival of human beings under the conditions of fossil fuel depletion and environmental pollution. In addition, as hybrid cars have appeared and portable wireless information and communication instruments, such as mobile phones and notebook computers, have been rapidly developed, importance of secondary batteries have been increased as portable power sources. Particularly, since lithium has an energy density that reaches 3860 mAh/g, secondary batteries using lithium as an anode material have been studied once due to their very high capacity. However, such secondary batteries using lithium as an anode material are disadvantageous in that they may cause a short circuit due to the growth of dendrite during charge processes and they show low charge/discharge efficiency.

To solve such problems of lithium as an anode material, studies about lithium alloys have been conducted actively. Lithium alloy materials are advantageous in that they realize a higher charge/discharge capacity per unit weight/volume as compared to a limited capacity (372 mAh/g, 840 mAh/cm³) of a carbon anode material and are amenable to high charge/discharge current. However, lithium alloy materials may cause a phase shift during charge/discharge processes. Such a phase shift of lithium alloy materials results in a change in volume and the stress generated therefrom breaks the active material, while reducing the capacity during the repetition of cycles.

Therefore, recently, active studies have been conducted to develop methods of using silicon, tin and antimony as an anode material for a secondary battery. In such methods, metal precursors of silicon, tin or antimony are mixed homogeneously with carbon in a liquid phase, and then silicon, tin and antimony metals are precipitated in carbon by way of various chemical methods to form a composite to be used as an electrode active material.

However, although the above methods allow an increase in the capacity of an electrode during the repetition of several initial cycles, they cannot provide high initial efficiency and cannot improve the high-rate charge/discharge characteristics and cycle characteristics.

Meanwhile, zinc has a theoretical capacity of 410 mAh/g or 2920 mAh/cm³ and antimony has a theoretical capacity of 660 mAh/g or 4420 mAh/cm³, and thus zinc and antimony are advantageous in that they provide a significantly higher capacity per weight or volume as compared to a carbon anode (372 mAh/g or 840 mAh/cm³). However, electrodes using zinc and antimony cause a change in volume due to a phase shift during charge/discharge processes, and the stress generated therefrom causes destruction of the active material, resulting in a drop in capacity after repeating cycles.

To minimize such a drop in capacity caused by a change in volume, use of nano-sized powder has been proposed. However, conventional nano-sized powder is obtained by a complicated chemical process such as a reduction process or co-precipitation process. Moreover, use of such nano-sized powder provides poor initial efficiency due to irreversible side reactions caused by the salts remaining after the chemical processes.

Further, agglomeration of such nano-sized powder may occur during the repetition of charge/discharge cycles to minimize the surface energy. There is another problem in that such agglomeration causes formation of crude particles and a change in volume, thereby causing a rapid drop in capacity after the repetition of cycles.

To solve such problems, Sony Corporation has developed a battery with a trade name of Nexcellion™, which has a Sn—Co—C composite anode formed by a ball milling process, in 2005. However, the Nexcellion battery has disadvantages in that the ball milling process is not time-efficient and expensive Co non-reactive to Li is used, and thus it is not possible to realize high cost efficiency and high capacity. Under these circumstances, there is an imminent need for developing a novel high-capacity anode material through a time-efficient process from inexpensive materials.

### SUMMARY

In one aspect, there is provided a method for preparing a zinc antimonide-carbon composite with high efficiency.

In another aspect, there are provided an anode material and a lithium secondary battery including the zinc antimonide-carbon composite obtained from the above method.

The zinc antimonide (ZnSb)-carbon (C) composite is obtained by a mechanical synthesis process of zinc (Zn), antimony (Sb) and carbon (C). An anode material and a lithium secondary battery including the composite as an active material are also provided.

The method disclosed herein has advantages in that the zinc antimonide-carbon composite is obtained efficiently and promptly using the mechanical properties of zinc antimonide, while avoiding a need for a complicated and inefficient chemical process. In addition, the anode material and the lithium secondary battery using the composite as an anode active material provide excellent initial efficiency, show no problem of a change in volume caused by formation of crude particles, and have excellent high-rate characteristics and charge/discharge characteristics.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIGS. 1a, 1b and 1c are graphs showing the results of X-ray diffractometry of zinc antimonide prepared by heat treatment, zinc antimonide prepared by ball milling and zinc antimonide-carbon composite with the lapse of ball milling time (1, 2, 3, 4, 5 and 6 hr), respectively;

FIGS. 2a, 2b and 2c are photographic views of the zinc antimonide-carbon composite obtained according to one embodiment of the method disclosed herein, taken by transmission electron microscopy (TEM), high-resolution TEM and energy dispersive spectroscopy (EDS), respectively;

FIG. 3a is a graph showing the charge/discharge behavior of a lithium secondary battery using the zinc antimonide-carbon composite according to one embodiment as an anode active material during the repetition of charge/discharge cycles;

FIG. 3b is a graph showing the cycle characteristics of the lithium secondary batteries using either of zinc antimonide-carbon composite and graphite (mesocarbon microbeads; MCMB) as an anode active material;

FIG. 4a is a graph showing the charge/discharge behavior in the high-rate characteristics of a lithium secondary battery using the zinc antimonide-carbon composite according to one embodiment as an anode active material; and

FIG. 4b is a graph showing the comparison of high-rate characteristics among the lithium secondary batteries each using zinc antimonide-carbon composite, zinc antimonide and graphite (MCMB) as an anode active material.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

According to one embodiment, the method for preparing a zinc antimonide (ZnSb)-carbon (C) includes preparing the zinc antimonide-carbon composite via mechanical synthesis processes of zinc (Zn), antimony (Sb) and carbon (C). Such mechanical synthesis processes include, for example, heat treatment, ball milling or any combinations thereof. In this manner, it is possible to obtain a zinc antimonide-carbon composite via a simple and rapid process, while avoiding a need for a complicated inefficient chemical process.

More particularly, the method includes: subjecting zinc and antimony to heat treatment or ball milling to form a binary alloy phase of zinc antimonide; and mixing the binary alloy phase of zinc antimonide with a carbon component, followed by ball milling, to obtain a zinc antimonide-carbon composite. In one embodiment, the carbon component to be mixed with the binary alloy phase of zinc antimonide may be provided in the form of powder. The method for preparing a zinc antimonide-carbon composite provides a composite in which the Zn/Sb binary alloy phase of zinc antimonide is uniformly mixed with the carbon component.

According to the method for preparing a zinc antimonide-carbon composite, it is possible to obtain a composite containing zinc antimonite grains dispersed uniformly therein and having a size less than 3 nm in a short time (within 6 hours) due to the mechanical properties, i.e., brittleness of the zinc antimonide alloy phase. It is also possible to reduce the manufacturing cost significantly as compared to cobalt (Co)-containing composites.

Further, it is possible to increase the capacity through the lithium-zinc and lithium-antimony reactions using zinc and antimony instead of cobalt non-reactive to lithium (Li).

In one embodiment, the mechanical synthesis processes may include a ball milling process. Particular examples of the ball milling process include processes using a vibratory mill, z-mill, planetary ball mill or attrition mill. The ball milling process may be carried out in any ball milling machines capable of ball milling. The zinc antimonide-carbon composite obtained from the ball milling process is advantageous in that it causes a small drop in the initial efficiency due to a decreased amount of irreversible side reactions.

In another embodiment, the method for preparing a zinc antimonide (ZnSb)-carbon composite includes: subjecting zinc and antimony to heat treatment or ball milling to form a binary alloy phase of zinc antimonide; and mixing the binary alloy phase of zinc antimonide with carbon powder, followed by ball milling, to obtain a zinc antimonide-carbon composite.

In the ball milling process, the temperature may increase to 200° C. or higher and the pressure may be applied to the mixture to a degree of 6 GPa or higher. Through such a process, the powder subjected to ball milling may cause firing deformation. Herein, the alloy phase of zinc antimonide may be provided with brittleness. In the case of a zinc antimonide-carbon composite, such brittleness of the zinc antimonide alloy phase facilitates the firing deformation during the ball milling. Therefore, it is possible to obtain a composite having grains with a small size in a simple and prompt manner.

As used herein, the term “brittleness”, also called brashness, refers the property of a material by which the material is not deformed permanently but is broken, or is deformed permanently only in a portion when applied a force to the material above the elastic limit thereof.

The zinc antimonide-carbon composite obtained by the method according to one embodiment causes a small drop in the initial efficiency due to a decreased amount of irreversible side reactions. In addition, when the composite is applied to a lithium secondary battery, it causes no agglomeration during the repetition of charge/discharge cycles, thereby preventing formation of crude particles. Therefore, there is no change in volume, thereby preventing the problem of a drop in capacity. Moreover, the composite has more improved characteristics, when the zinc antimonide grains have a nano-scaled particle size.

When utilizing the zinc antimonide-carbon composite as an anode material for a secondary battery, particularly a lithium secondary battery, a smaller zinc antimonide grain size provides better high-rate characteristics and charge/discharge characteristics. Therefore, the zinc antimonide grains may have a nano-scaled average particle size. In one embodiment, the zinc antimonide grains have an average particle size of 10 nm or less, particularly 0.01-10 nm, and more particularly 0.1-3 nm. When the zinc antimonide grains have an average particle size less than 10 nm, it is possible to improve the electrochemical properties as described above, and to effectively control the particle agglomeration phenomenon during the repetition of charge/discharge cycles because the zinc antimonide grains are dispersed well in the amorphous carbon component. Therefore, it is possible to realize effective repetition of charge/discharge cycles in a secondary battery. As a result, the zinc antimonide-carbon composite disclosed herein realizes a higher capacity per unit weight/volume as compared to the theoretical capacity of commercially available graphite, and provides excellent cycle life characteristics.

In one embodiment, although there is no particular limitation in carbon, the carbon may be at least one selected from the group consisting of acetylene black, Super P black, carbon black, Denka black, activated carbon, graphite, hard carbon and soft carbon. Such carbon components are non-reactive to metals, have conductivity and prevent particle agglomeration.

In another embodiment, the carbon may be Super P or carbon black. Since Super P or carbon black particles have a nano-scaled size, they are favorable to formation of nanocomposites. For example, in the case of a metal, such as a zinc antimonide binary phase, having strong brittleness, nanocomposites may be effectively obtained by mixing the metal with nano-sized Super P, followed by ball milling.

In one embodiment, the zinc antimonide-carbon composite includes zinc antimonide and carbon in such a mixing ratio that zinc antimonide is present in an amount equal to or more than 30 wt % and less than 100 wt % and carbon is present in an amount more than 0 wt % and equal to or less than 70 wt %, based on the total weight of the composite. When zinc antimonide is present in an amount less than 30 wt %, i.e., carbon is present in an amount more than 70 wt %, the carbon component may be subjected excessively to ball milling, thereby causing a drop in charge/discharge capacity and efficiency of a secondary battery at the first cycle, resulting in a drop in the overall capacity and efficiency of the battery. More particularly, zinc antimonide may be used in an amount equal to or more than 40 wt % and less than 80 wt %, and carbon may be used in an amount more than 20 wt % and equal to or less than 60 wt %. By using such a certain amount of carbon content, it is possible to control the agglomeration of zinc antimonide grains and to impart a nano-scaled particle size to zinc antimonide grains.

In one embodiment, the binary alloy phase of zinc antimonide includes zinc or antimony in an amount of 20-80 wt %, based on the combined weight of zinc and antimony. When either zinc or antimony is present in an excessive amount, a zinc phase or antimony phase that cannot form a zinc-antimony alloy phase may exist. Since such an individual zinc or antimony phase has poor electrochemical properties as compared to the zinc-antimony alloy phase, the overall composite may provide poor cycle characteristics.

In one embodiment of the method disclosed herein, graphite may be further added during the mechanical alloy formation of the zinc antimonide-carbon composite. This is for preventing agglomeration of the zinc antimonide alloy during the ball milling work, etc., for accelerating formation of nano-scaled zinc antimonide grains and for imparting an additional capacity from graphite.

Hereinafter, one particular embodiment of the method disclosed herein will be explained in more detail.

First, a mixture of zinc with antimony is heat treated at 500° C. under argon atmosphere for 3 hours to form a binary alloy phase of zinc antimonide. Otherwise, a mixture of zinc with antimony is introduced into a cylindrical vial together with balls and the vial is mounted to a high-energy ball milling machine. Then, a ball milling machine may be rotated at a speed of 300 rpm or higher to perform mechanical synthesis and to obtain a binary alloy phase of zinc antimonide.

Next, a mixture of zinc antimonide with carbon is introduced into a cylindrical vial together with balls and the vial is mounted to a high-energy ball milling machine. The ball milling machine is rotated under a speed of 300 rpm or higher to perform mechanical synthesis and to obtain a binary alloy phase of zinc antimonide-carbon composite. Herein, the weight ratio of the balls to the composite powder is maintained at 10:1 to 30:1. In addition, ball milling is carried out in a glove box under argon gas atmosphere to inhibit the effects of oxygen and moisture to the highest degree. While the ball milling is carried out, the mixture may be heated to a temperature of 200° C. or higher and may be subjected to a pressure of 6 GPa or higher.

Meanwhile, during the preparation of the zinc antimonide-carbon composite disclosed herein, other materials capable of improving the electrochemical properties of a secondary battery may be further added.

In one embodiment, besides zinc antimonide and carbon, at least one component, for example, selected from the group consisting of silicon (Si), phosphorus (P), germanium (Ge), aluminum (Al), gallium (Ga), indium (In), thallium (Tl), lead (Pb), arsenic (As), bismuth (Bi), magnesium (Mg), calcium (Ca), silver (Ag), tin (Sn), cadmium (Cd), boron (B) and sulfur (S), may be further added in order to improve the reactivity to lithium.

In another embodiment, at least one component selected from the group consisting of scandium (Sc), titanium (Ti), vanadium (V), chrome (Cr), manganese (Mn), iron (Fe), cobalt (Co), nickel (Ni), copper (Cu), yttrium (Y), zirconium (Zr), niobium (Nb), molybdenum (Mo), technetium (Tc), rubidium (Ru), lanthanum (La), hafnium (Hf), tantalum (Ta) and tungsten (W) may be further added in order to improve the conductivity of the zinc antimonide-carbon composite.

In still another embodiment, at least one component selected from the group consisting of metal oxides and metal carbides may be further added in order to improve the mechanical properties of the zinc antimonide-carbon composite.

In another aspect, there are provided a zinc antimonide-carbon composite obtained by the above method, and an anode material for a secondary battery including the composite as an active material. The secondary battery including the anode material may be obtained by conventional processes known to those skilled in the art. In other words, a porous separator may be inserted between a cathode and an anode, and an electrolyte may be injected thereto. The secondary battery may be a lithium secondary battery having high energy density, discharge voltage and output stability.

### Examples

The examples and experiments will now be described. The following examples and experiments are for illustrative purposes only and not intended to limit the scope of this disclosure.

### Example 1

### Preparation of Zinc Antimonide (ZnSb)-Carbon Composite

1-1. Preparation of Binary Alloy Phase of Zinc Antimonide

First, commercially available zinc powder having an average particle size of 20 μm was mixed with commercially available antimony powder having an average particle size of 100 μm at a molar ratio of 1:1, and then the mixture was heat treated at 500° C. for 3 hours under argon atmosphere to obtain powder of a binary alloy phase of zinc antimonide.

Otherwise, a mixture containing zinc and antimony powder at a molar ratio of 1:1 was introduced into a cylindrical vial made of SKD11 and having a diameter of 5.5 cm and a height of 9 cm together with balls with a size of ⅜ inches, and the vial was mounted to a ball milling system (Spex 8000-vibrating mill) to perform mechanical synthesis. At that time, the weight ratio of the balls to the mixed powder was maintained at 20:1, and the mechanical synthesis was carried out in a glove box under argon gas atmosphere in order to inhibit the effects of oxygen and moisture to the highest degree. The mechanical synthesis was performed for 6 hours to obtain powder of a binary alloy phase of zinc antimonide.

1-2. Preparation of Zinc Antimonide-Carbon Composite

The zinc antimonide obtained from Example 1-1 was mixed with carbon powder at a weight ratio of 70:30, and the mixture was introduced into a cylindrical vial made of SKD11 and having a diameter of 5.5 cm and a height of 9 cm together with balls having a size of ⅜ inches. Next, the vial was mounted to a ball milling system (Spex 8000-vibrating mill) to perform mechanical synthesis. At that time, the weight ratio of the balls to the powder was maintained at 20:1, and the mechanical synthesis was carried out in a glove box under argon gas atmosphere in order to inhibit the effects of oxygen and moisture to the highest degree. The mechanical synthesis was performed for 6 hours to obtain a nanocomposite containing nano-sized zinc antimonide grains and carbon component.

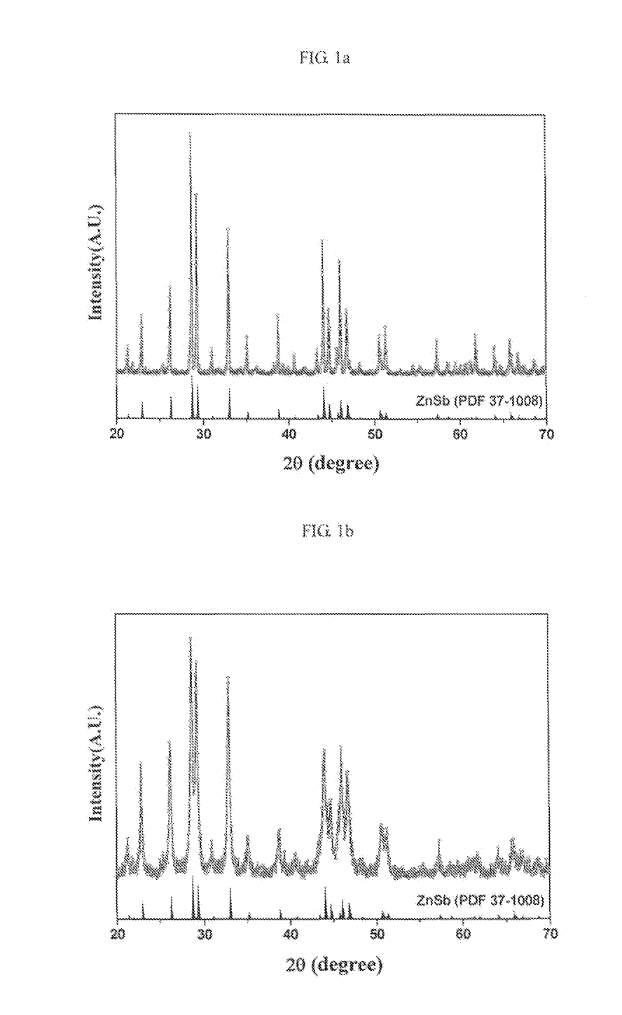

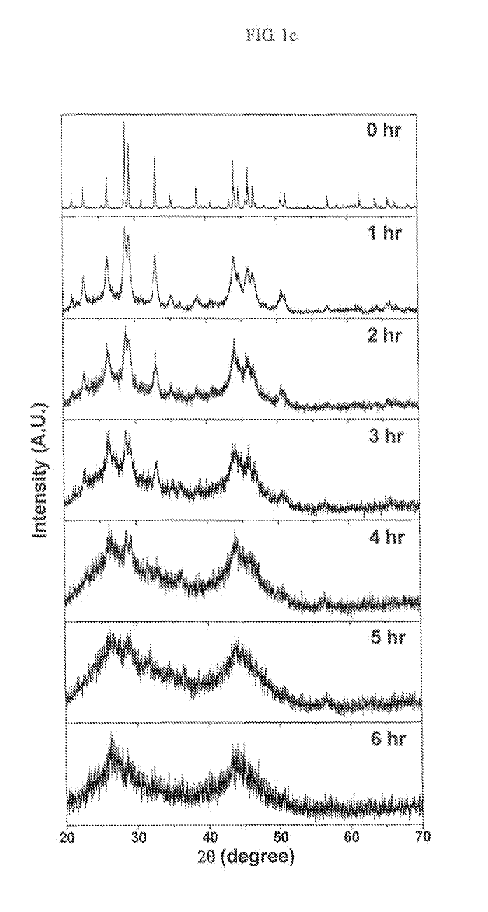

FIGS. 1a and 1b are the results of X-ray diffractometry of the powder of the binary alloy phases of zinc antimonide prepared by heat treatment and ball milling, respectively. FIG. 1c is the result of X-ray diffractometry illustrating that the zinc antimonide-carbon composite becomes amorphous with the lapse of ball milling time. Within a short time of 6 hours, the zinc antimonide-carbon composite powder becomes amorphous or forms a nanocomposite.

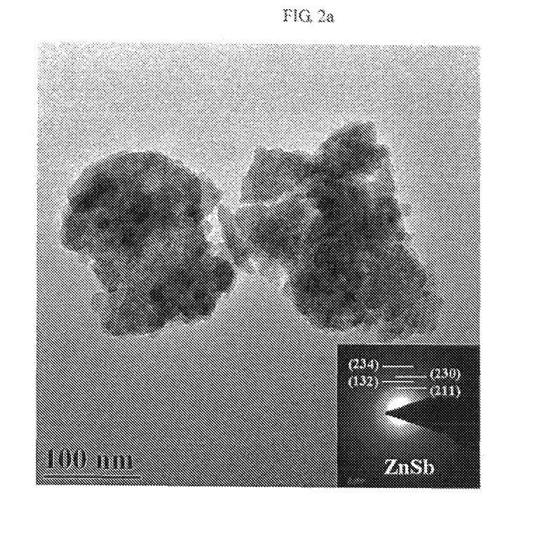

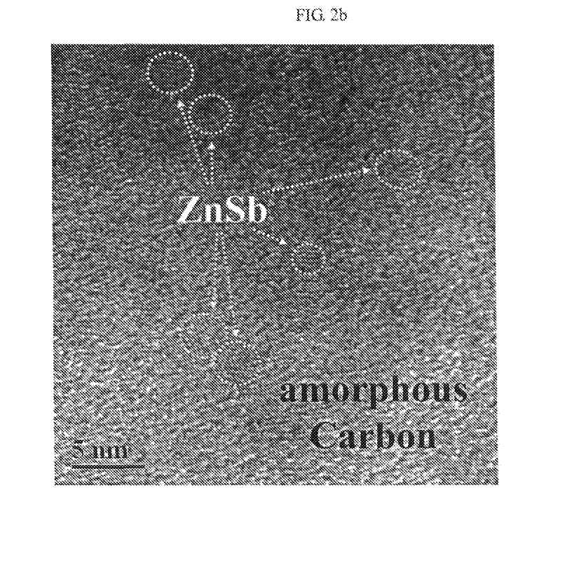

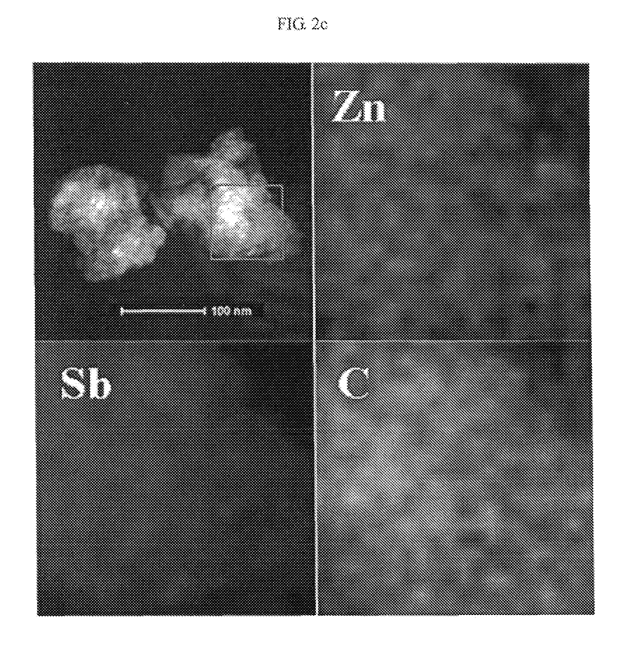

In addition, FIGS. 2a-2c are photographic views of the nanocomposite containing zinc antimonide-carbon, taken by transmission electron microscopy (TEM). As can be seen from FIGS. 2a and 2b, zinc antimonide grains having a size of 3 nm or less are formed along with amorphous carbon. As can be seed from FIG. 2c, a nanocomposite is formed and the nanocomposite includes zinc antimonide grains having a size of about 3 nm or less and distributed uniformly in amorphous carbon.

### Example 2

### Production of Secondary Battery Using Zinc Antimonide (ZnSb)-Carbon (C) Composite as Anode Active Material

First, an electrode sheet was provided by adding 70 wt % of the zinc antimonide-carbon composite obtained from Example 1 as an anode active material, 15 wt % of Super-P (conductive agent) and 15 wt % of PVdF (binder) to N-methyl pyrrolidone (NMP) to form anode mixture slurry. The slurry was coated on copper foil and dried in a vacuum oven at 120° C. for 3 hours. Also, lithium foil was used as a counter electrode or reference electrode.

As a separator, Cellguard™ (insulating thin film having high ion peimeability and mechanical strength) was used. As an electrolyte, ethylene carbonate (EC)/diethyl carbonate (DEC) (1:1 by volume) containing 1M LiPF₆ salt was used.

A self-made coin cell type half cell was used to perform charge/discharge cycles while applying a constant current at a voltage range of 0-2 V. This was made in a glove box to avoid the cell from being in contact with air. Lithium intercalation/deintercalation occurred during charge cycles and discharge cycles, respectively.

### Comparative Example 1

Example 2 was repeated to provide a lithium secondary battery, except that zinc antimonide alloy powder was used as an anode active material instead of the zinc antimonide-carbon composite.

### Comparative Example 2

Example 2 was repeated to provide a lithium secondary battery, except that graphite (mesocarbon microbeads; MCMB) was used as an anode active material instead of the zinc antimonide-carbon composite.

### Test Examples

### Test Example 1

### Determination of Charge/Discharge Characteristics of Lithium Secondary Batteries Depending on Types of Anode Active Materials

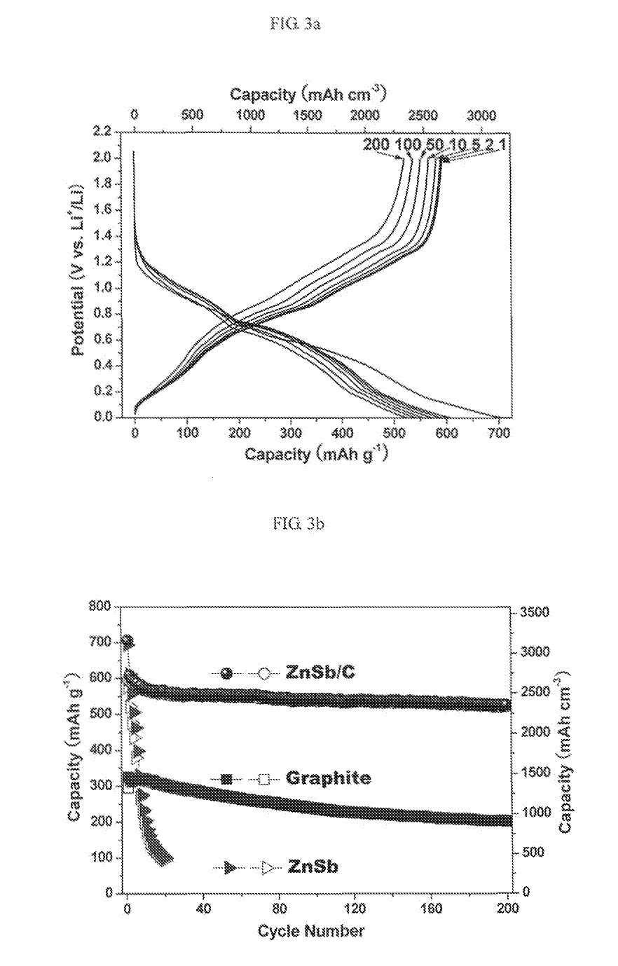

The lithium secondary battery of Example 1 was subjected to 1, 2, 5, 10, 50, 100 and 200 charge/discharge cycles, and its charge/discharge behaviors were determined. The results are shown in FIG. 3a.

Additionally, the lithium secondary batteries of Example 1 and Comparative Examples 1 and 2 were subjected to charge/discharge cycles and their cycle characteristics were determined. The results are shown in FIG. 3b.

Table 1 shows the charge capacity and discharge capacity at the first cycle, the initial efficiency and the cycle maintenance of the lithium secondary batteries using either of zinc antimonide (Comp. Ex. 1) and zinc antimonide-carbon composite (Ex. 1) as an anode active material.

TABLE 1

| | First (1^{st}) | First (1^{st}) | | Cycle |
|---|---|---|---|---|
| | Charge | Discharge | Initial | Maintenance |
| Type of Anode | Capacity | Capacity | Efficiency | (X^{th}/1^{st} |
| Active Material | (mAh/g) | (mAh/g) | (%) | discharge) (%) |
| Zinc Antimonide | 694 | 576 | 83 | 16; X = 20 |
| (ZnSb) | | | | |
| Zinc Antimonide | 705 | 596 | 85 | 88; X = 200 |
| (ZnSb)-Carbon (C) | | | | |
| Composite | | | | |

As can be seen from FIG. 3b, the electrode using zinc antimonide causes a significant drop in charge/discharge characteristics after 20 cycles.

On the contrary, as can be seen from FIG. 3b and Table 1, the electrode using the zinc antimonide-carbon composite causes little drop in charge/discharge characteristics even after 200 cycles. Moreover, as can be seen from the fact that the first charge capacity and the first discharge capacity are 705 mAh/g and 596 mAh/g, respectively, and the initial efficiency is about 85%, the electrode using the zinc antimonide-carbon composite shows excellent charge/discharge characteristics.

### Test Example 2

### Determination of Capacity Characteristics of Lithium Secondary Batteries

The capacity characteristics of the lithium secondary batteries of Example 1 and Comparative Example 2 were determined as a function of charge/discharge cycles.

FIG. 3b is a graph showing the cycle characteristics of the lithium secondary batteries using either of the zinc antimonide (ZnSb)-carbon (C) nanocomposite and graphite (MCMB) as an anode active material.

As can be seen from FIG. 3b, Example 1 using the zinc antimonide-carbon nanocomposite as an anode active material shows very stable life characteristics while maintaining a high capacity of 520 mAh/g (88% of the initial capacity) or higher at a reaction potential of 0-2 V even after 200 cycles. This is significantly better than Comparative Example 2 using graphite (MCMB) as an anode active material.

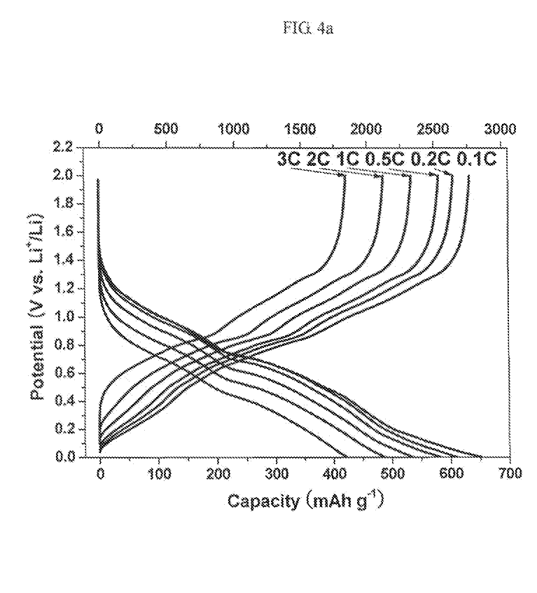

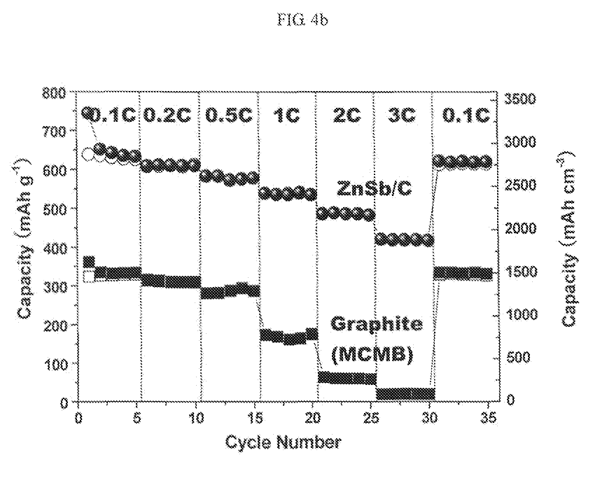

FIG. 4 is a graph showing the high-rate characteristics of the lithium secondary batteries using either of the zinc antimonide-carbon nanocomposite (Ex. 1) and graphite (MCMB) (Comp. Ex. 2) as an anode active material. Table 2 shows the C-rate discharge capacities of the above secondary batteries. For reference, in Table 2, C means that the corresponding battery is fully charged for 1 hour based on charge capacity (630 mAh/g). In other words, 1C and 2C mean that the battery is fully charged within 1 hour and 30 minutes, respectively.

TABLE 2

| Type of Anode | 0.1 C | 0.2 C | 0.5 C | 1 C | 2 C | 3 C |
|---|---|---|---|---|---|---|
| Active Material | [63 mA/g] | [126 mA/g] | [315 mA/g] | [630 mA/g] | [1260 mA/g] | [1890 mA/g] |
| Zinc Antimonide | ca. 630 mAh/g | ca. 610 mAh/g | ca. 580 mAh/g | ca. 535 mAh/g | ca. 485 mAh/g | ca. 420 mAh/g |
| (ZnSb)-Carbon (C) | | | | | | |
| composite | | | | | | |
| Type of Anode | 0.1 C | 0.2 C | 0.5 C | 1 C | 2 C | 3 C |
| Active Material | [33 mA/g] | [66 mA/g] | [165 mA/g] | [330 mA/g] | [660 mA/g] | [990 mA/g] |
| Graphite (MCMB) | ca. 330 mAh/g | ca. 310 mAh/g | ca. 280 mAh/g | ca. 160 mAh/g | ca. 60 mAh/g | ca. 20 mAh/g |

As can be seen from FIG. 4 and Table 2, the secondary battery of Example 1 shows excellent cycle characteristics while maintaining a capacity of about 535 mAh/g and 485 mAh/g, under a reaction potential of 0-2 V at a charge/discharge rate of 1C and 2C, respectively. Even at a rapid charge/discharge rate of 3C, the secondary battery shows very stable life characteristics while maintaining a capacity of 420 mAh/g.

As can be seen from the foregoing, when using the zinc antimonide (ZnSb)-carbon (C) nanocomposite disclosed herein as an anode material for a lithium secondary battery, it is possible to minimize the destruction of an anode material caused by a change in volume of the anode material during the repetition of charge/discharge cycles. Therefore, it is possible to ensure the mechanical stability, which is one of the most important properties required for an anode for a lithium secondary battery. Further, it is possible for the lithium secondary battery using the zinc antimonide-carbon nanocomposite to realize high capacity and excellent cycle characteristics.

Particularly, it can be seen from the above results that the secondary battery using the zinc antimonide-carbon nanocomposite maintains a capacity of 420 mAh/g even under a high charge/discharge rate of 3C and provides very stable cycle characteristics. Therefore, the secondary battery may be applied to various systems requiring excellent high rate characteristics or high power output.

The method disclosed herein allows efficient preparation of a zinc antimonide-carbon composite. The zinc antimonide-carbon composite may be useful as an anode material for a lithium secondary battery.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A method for preparing a zinc antimonide-carbon composite, comprising forming a zinc antimonide (ZnSb)-carbon (C) composite through a mechanical synthesis process of zinc (Zn), antimony (Sb) and carbon (C).

2. The method for preparing a zinc antimonide-carbon composite according to claim 1, wherein the mechanical synthesis process comprises a heat treatment or ball milling process.

3. The method for preparing a zinc antimonide-carbon composite according to claim 1, which comprises:
subjecting zinc and antimony to heat treatment or ball milling to form a binary alloy phase of zinc antimonide; and
mixing the binary alloy phase of zinc antimonide with carbon powder, followed by ball milling, to obtain a zinc antimonide-carbon composite.

4. The method for preparing a zinc antimonide-carbon composite according to claim 3, wherein the binary alloy phase of zinc antimonide comprises at least one selected from the group consisting of ZnSb, Zn₄Sb₃, Zn₃Sb₂ and Zn₂Sb₃.

5. The method for preparing a zinc antimonide-carbon composite according to claim 1, wherein the zinc antimonide-carbon composite comprises zinc antimonide grains having an average particle size of 10 nm or less.

6. The method for preparing a zinc antimonide-carbon composite according to claim 5, wherein the zinc antimonide grains have an average particle size of 0.1-3 nm.

7. The method for preparing a zinc antimonide-carbon composite according to claim 1, wherein the carbon comprises at least one selected from the group consisting of acetylene black, Super P black, carbon black, Denka black, activated carbon, graphite, hard carbon and soft carbon.

8. The method for preparing a zinc antimonide-carbon composite according to claim 7, wherein the carbon is Super P black or carbon black.

9. The method for preparing a zinc antimonide-carbon composite according to claim 1, wherein the zinc antimonide-carbon composite comprises the zinc antimonide in an amount equal to or more than 30 wt % and less than 100 wt %, and the carbon in an amount more than 0 wt % and equal to or less than 70 wt %, based on the total weight of the composite.

10. The method for preparing a zinc antimonide-carbon composite according to claim 1, wherein the zinc or antimony is present in an amount of 20-80 wt % based on the combined weight of zinc and antimony.

11. The method for preparing a zinc antimonide-carbon composite according to claim 1, wherein graphite is further added during the mechanical alloying for forming the zinc antimonide-carbon composite.

12. The method for preparing a zinc antimonide-carbon composite according to claim 1, wherein at least one component selected from the group consisting of silicon (Si), phosphorus (P), germanium (Ge), aluminum (Al), gallium (Ga), indium (In), thallium (Tl), lead (Pb), arsenic (As), bismuth (Bi), magnesium (Mg), calcium (Ca), silver (Ag), tin (Sn), cadmium (Cd), boron (B) and sulfur (S) is further added during the preparation of the zinc antimonide-carbon composite.

13. The method for preparing a zinc antimonide-carbon composite according to claim 1, wherein at least one component selected from the group consisting of scandium (Sc), titanium (Ti), vanadium (V), chrome (Cr), manganese (Mn), iron (Fe), cobalt (Co), nickel (Ni), copper (Cu), yttrium (Y), zirconium (Zr), niobium (Nb), molybdenum (Mo), technetium (Tc), rubidium (Ru), lanthanum (La), hafnium (Hf), tantalum (Ta) and tungsten (W) is further added during the preparation of the zinc antimonide-carbon composite.

14. The method for preparing a zinc antimonide-carbon composite according to claim 1, wherein at least one component selected from the group consisting of metal oxides and metal carbides is further added during the preparation of the zinc antimonide-carbon composite in order to improve mechanical properties of the zinc antimonide-carbon composite.

15. An anode material for a secondary battery, which comprises, as an active material, the zinc antimonide-carbon composite obtained by the method as defined in claim 1.

16. A lithium secondary battery comprising the anode material as defined in claim 15.
